(19) United States
(12) Patent Application Publication
(10) Pub. No.: US 2025/0114969 A1
(43) Pub. Date: Apr. 10, 2025

(54) ATTACHMENT DESIGN AND METHODOLOGY FOR DIRECT CARBONATION OF THIXOTROPIC CEMENTITIOUS COMPOSITE FLUIDS

(71) Applicants: Saudi Arabian Oil Company, Dhahran (SA); Nanyang Technological University, Singapore (SG)

(72) Inventors: Sean Gip Lim, Singapore (SG); Ming Jen Tan, Singapore (SG); Daniel Yi Wei Tay, Singapore (SG); Bandar Abdullah Fadhel, Dhahran (SA); Issam Thaher Amr, Dhahran (SA); Suvash Chandra PAUL, Singapore (SG)

(73) Assignee: Saudi Aramco Technologies Company, Dhahran (SA)

(21) Appl. No.: 18/906,607

(22) Filed: Oct. 4, 2024

Related U.S. Application Data
(60) Provisional application No. 63/588,154, filed on Oct. 5, 2023.

(51) Int. Cl. B28B 1/00; B28B 17/02; B33Y 10/00; B33Y 30/00

(52) U.S. Cl. CPC B28B 1/001; B28B 17/02; B33Y 10/00; B33Y 30/00

(57) ABSTRACT

A printhead for three-dimensional printing of concrete includes a main body and a regulator device. The main body includes a multi-stage, convergent-divergent cylinder, shearing blades, a pressure chamber, and a secondary inlet. The pressure chamber surrounds the cylinder for temporary storage and regulated processing of a secondary fluid. The secondary inlet transfers the secondary fluid from the pressure chamber to the multi-stage, convergent-divergent cylinder to form a mixture, which is discharged from the printhead. The printhead can, for example, be used for additive manufacturing of cement-based materials.

### CROSS-REFERENCE TO RELATED PATENT APPLICATIONS

This application claims the benefit of U.S. Provisional Application No. 63/588,154, filed Oct. 5, 2023, the contents of which are incorporated by reference herein.

### TECHNICAL FIELD

The following disclosure relates to additive manufacturing, and in particular, additive manufacturing of cementitious materials.

### BACKGROUND

Additive manufacturing is the construction of a three-dimensional (3D) object in which material is deposited, joined, solidified, or any combinations of these. The material can be added together, typically layer-by-layer. The precision, repeatability, and material range of 3D printing have increased to the point that some 3D printing processes can be considered viable as an industrial production technology.

3D concrete printing is a specific type of 3D printing which involves digital fabrication processes for cementitious materials based on 3D printing technology. Some examples of architectural and structural applications of 3D-printed concrete include production of building blocks, building modules, street furniture, pedestrian bridges, and low-rise residential structures.

### SUMMARY

This disclosure describes technology generally related to additive manufacturing. The concepts described can be applied to direct carbonation of fluid cementitious materials by use of an attachment design, which can, for example, be used in 3D construction printing applications. Other potential applications of the described attachment and/or method can include conventional pump delivery of concrete and shotcrete.

The subject matter described in this disclosure can be implemented in particular implementations, so as to realize one or more of the following advantages. In some implementations, designs and principles of the described additive manufacturing processes and printheads facilitate high-pressure in-line mixing of fluids with stiff granular mediums containing relatively large particles. In some implementations, the described printhead can accommodate particles of variable sizes without needing to increase pressure proportionally. In some implementations, the described printhead can minimize and/or eliminate cleaning efforts, risks of clogging, and pressure losses even when operated for prolonged periods of time. In some implementations, the described printhead allows for increased homogeneous intermixing of fluids with stiff granular mediums up to deposition. Further, carbon dioxide used to carbonate cement in the described additive manufacturing processes and systems can be sourced from carbon dioxide that has been captured from other processes, such as industrial processes that produce carbon dioxide (for example, flue gas). The described printheads and methods can be used to carbonate concrete during 3D printing of concrete. The described printheads and methods can enhance buildability of 3D printed concrete, which can accelerate construction processes that utilize the 3D printed concrete. The described printheads and methods can increase the storage capacity for captured carbon dioxide in the 3D printed concrete, which facilitates decarbonization efforts. The described printheads and methods can improve the mechanical properties of the concrete that is 3D printed, such as increased compressive strength, increased flexural stiffness, and refined pore structure.

### DESCRIPTION OF DRAWINGS

FIG. 1 shows a front schematic diagram and a cross-sectional schematic diagram of an example printhead that can be used in additive manufacturing.

FIG. 2A shows cross-sectional schematic diagrams of an example printhead.

FIG. 2B shows a cross-sectional schematic diagram of the example printhead of FIG. 2A showing flow of fluid through the example printhead.

FIG. 3 is a schematic diagram of an example system that includes a printhead.

FIG. 4 is a plot of X-ray diffraction (XRD) spectra of a reference cement sample.

FIG. 5 is a plot showing derivative thermogravimetry curves of a thermogravimetric analysis (TG-DTG) for a reference cement mix.

FIG. 6 is a plot showing TG-DTG curves for a cement mix including carbon dioxide and steam additives.

FIG. 7 is a plot comparing compressive strength of cement samples.

FIG. 8 is a plot comparing flexural strength of cement samples.

### DETAILED DESCRIPTION

This disclosure describes concepts and principles of an attachment design and methodology that enables direct carbonation of cementitious mixtures during its pumping and/or deposition phase for 3D concrete printing applications. Key advantages of this technology over current existing methods to achieve accelerated carbonation of cementitious materials, such as the application of confined carbon dioxide (CO₂)-concentrated chambers, include scalability for architectural applications and automation, adaptability for ease of integration with appliances involving transportation of cementitious products, as well as minimal requirements for additional labor and energy-intensive equipment. Preliminary studies conducted using a prototype device, as per disclosure and a printable ordinary Portland cement (OPC) mix design, have yielded carbon uptakes of up to 18.4 wt. % binder near the surface of extrusion-based 3D concrete printed (3DCP) samples and 6.4 wt. % binder across the entire cross-section of a transversely sliced sample. Compressive and flexural strengths of said samples have also been observed to range from 26.2-49.2 megapascals (MPa) and 5.5-8.8 MPa, respectively.

Common to both 3D concrete printing and conventional methods of construction is the use of cement and supplementary cementitious materials as binding agents. These binder ingredients, depending on source, typically contain significant amounts of alkaline-earth oxides, which are capable of reacting with pozzolanic materials (e.g., silica fume, fly ash, and burnt clay) and water to form hydration products such as calcium/magnesium hydroxide, calcium/magnesium silicate hydrates, Al₂O₃—Fe₂O₃-tri (Aft) and Al₂O₃—Fe₂O₃-mono (AFm) phases. In general, formation of these hydration products plays a critical role in the mechanical strength developments of concrete.

However, apart from being responsible for the hydraulic binding properties of cementitious products, these alkaline-earth oxides are also capable of reacting with both carbon dioxide and water to produce stable carbonate minerals. The stable carbonates (i.e., calcium carbonate and magnesium carbonate) are insoluble in water and possess considerably high decomposition temperatures, thus serving as an excellent option for permanent sequestration of carbon dioxide as a greenhouse gas. A process of this reaction, also known as carbon mineralization, thereafter, serves as a key principle towards carbon capture and sequestration with cementitious construction materials. The main challenge, however, is that while carbonation of cementitious materials occurs naturally even at ambient conditions, it remains too slow of a process to offset the immediate carbon footprint of modern-day building and construction activities. Moreover, actual rates and depths of carbon mineralization in concrete walls/structures are dependent on the gas permeability of the concrete, which can be correlated to the pore size distribution of the concrete. As exposed surfaces of the exterior wall carbonate and thus densify, the permeability for gases to penetrate diminishes which prevents the material from fulfilling its maximum potential as a carbon sink. To accelerate the carbonation and chemical reaction processes of cementitious structures on an impactful scale is the primary intended objective.

A review of existing literature suggests that carbon curing with confined chambers at adequate treatment conditions provides a feasible solution towards improving CO₂-uptake of precast concretes. However, though proven to work from an academic perspective, the use of confined chambers for carbon sequestration of cementitious products remains inadequate for mass adoption in the building and construction industry. Reasons attributed to this phenomenon include challenges, such as a lack of scalability, especially with advanced technologies that are currently geared towards automated construction due to size restrictions, as well as a reduction of logistical efficiency due to additional procedures required to execute the carbon curing process. This translates to a possible increase in time, labor, and environmental costs, which is highly unfavorable from a business viewpoint. Moreover, limited studies have been conducted to understand possibilities of carbon sequestration by injecting carbon dioxide directly into fresh cementitious mortars during pumping and deposition phases for 3D concrete printing applications.

Some conventional 3D printers face several technical challenges when dealing with fluids including granular mediums. For example, stiff, dense mediums may require potential incorporation of large, irregularly sized particles, which can pose problems, such as clogging and blockage of printer nozzles during the additive manufacturing process. Clogging and blockage of printer nozzles may be particularly prevalent when injecting gases at high pressure into granular mediums, which can typically be found in 3D printable concrete mixes that include accelerator additives. The presence of rapid stiffening effects with these mediums can further exacerbate issues, which can lead to clogging, process inefficiencies, and safety concerns, especially in cases where gas pressures are not appropriately regulated. If left to operate over prolonged durations of time, the integration of internal cleaning mechanisms become necessary, or else hardening of reactive mediums (e.g., cementitious materials) may compromise the longevity of the printhead nozzle compartments.

Another significant issue encountered by conventional 3D printers is the inefficient integration of gases, which can lead to excess waste of gas. The use of high pressures for injecting gas into cement mixtures during 3D printing processes can contribute to unnecessary waste and unnecessary pressure loss of the injected fluid, coupled with heterogeneity of the 3D printed material owing to the inherent behavior of granular mediums. Such inefficient injection of gas can result in uneven mixing, which can compromise the quality and consistency of the final 3D printed product.

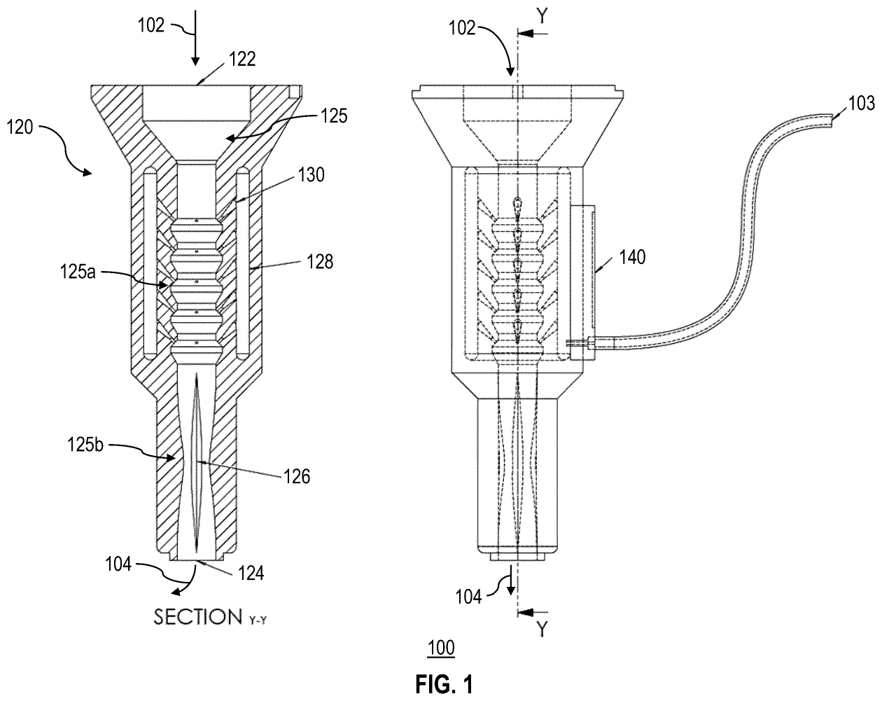

A typical 3D construction printer would generally include components, such as a mixer, positive displacement pump, robotic manipulator, delivery tubing, and printhead. As illustrated in FIG. 1, possible areas of having the attachment design integrated onto a gantry printer may include either if not both the printhead and output end of the positive displacement pump. A key objective and novelty of this printhead design is to achieve accelerated rates of carbonation in cementitious mixtures using an original method of material processing during pumping and/or deposition phases.

The described additive manufacturing methods can be classified into three primary segments: 1) diffusion of secondary fluid(s) (e.g., carbon dioxide and/or chemical additives) into a highly viscous primary medium (e.g., cementitious mortar), 2) cyclical expansion and compression of multiphase mixture to facilitate adequate homogeneity and compaction, and 3) energizing of the primary and/or secondary fluid(s) via an external regulator device for accelerated chemical reactions.

FIG. 1 shows a front schematic diagram (left) and a cross-sectional schematic diagram (right) of an example printhead 100 that can be used in additive manufacturing. The printhead 100 is adapted for an additive manufacturing printer. As a particular example, the printhead 100 is adapted for a gantry printer located at the Singapore Centre for 3D Printing at Nanyang Technological University (NTU). The printhead 100 includes a main body 120 and a regulator device 140. The main body 120 includes a first inlet 122, an outlet nozzle 124, a shearing blade 126, a pressure chamber 128, and a secondary inlet 130. The first inlet 122 is configured to receive a primary fluid 102. The primary fluid 102 includes a cementitious material, for example, including granular medium(s). For example, the primary fluid 102 includes cementitious mortar. The outlet nozzle 124 is configured to discharge a cementitious composite material 104 for 3D printing of the cementitious composite material 104. The first inlet 122 and the outlet nozzle 124 are located at opposing ends of the main body 120. The main body 120 defines an inner bore 125 extending from the first inlet 122 to the outlet nozzle 124. The primary fluid 102 flows through the inner bore 125 of the main body 120. The inner bore 125 includes a convergent-divergent section 125a and a shearing section 125b. The shearing section 125b can be located closer to the outlet nozzle 124 in comparison to the convergent-divergent section 125a. In some implementations, as shown in FIG. 1, the convergent-divergent section 125a is a multi-stage convergent-divergent cylinder. The pressure chamber 128 surrounds at least a portion of the inner bore 125.

The pressure chamber 128 is configured to house a secondary fluid 103. For example, the pressure chamber 128 temporarily stores and regulates processing of the secondary fluid 103. The secondary fluid 103 can include, for example, carbon dioxide, chemical additive(s), or both.

The secondary inlet 130 extends from the pressure chamber 128 to the convergent-divergent section 125a of the inner bore 125. The secondary inlet 130 has a tapered (e.g., decreasing) diameter closer to the inner bore 125 for transferring the secondary fluid 103 from the pressure chamber 128 to the inner bore 125. By the tapered diameter, the secondary inlet 130 is configured to mitigate and/or eliminate the risk of reverse flow (e.g., from the inner bore 125 to the pressure chamber 128). In some implementations, as shown in FIG. 1, the main body 120 includes multiple secondary inlets 130, for example, distributed around a circumference of the inner bore 125 in the convergent-divergent section 125a and/or distributed along at least a portion of a longitudinal length of the convergent-divergent section 125a.

The shearing blade 126 is disposed within the shearing section 125b of the inner bore 125. The shearing blade 126 is configured to provide shear force onto the primary fluid 102 and the secondary fluid(s) 103, thereby promoting mixing of and interaction between the primary fluid 102 and the secondary fluid 103 to produce the cementitious composite material 104. In some implementations, as shown in FIG. 1, the main body 120 includes multiple shearing blades 126.

The regulator device 140 is configured to couple to the pressure chamber 128 of the main body 120 for providing the secondary fluid(s) 103 to the pressure chamber 128. The regulator device 140 is configured to regulate flow of the secondary fluid(s) 103 into the pressure chamber 128 and subsequently into the inner bore 125 via the secondary inlet(s) 130. The regulator device 140 can include an emulsifier configured to facilitate agitation and homogeneous mixing of the primary fluid 102 and the secondary fluid(s) 103. The regulator device 140 can include a heater configured to heat the secondary fluid(s) 103 prior to the secondary fluid(s) 103 being injected from the pressure chamber 128 into the inner bore 125. The regulator device 140 is configured to impart energy (e.g., thermal energy, kinetic energy, or both) to the secondary fluid(s) 103, which facilitates acceleration of chemical reactions between the primary fluid 102 and the secondary fluid(s) 103 to form the cementitious composite material 104 within a pressure-controlled environment (e.g., within the inner bore 125.

The direct carbonation of primary fluid 102 at an accelerated rate, therefore, is projected to occur under the influence of energy transfer from the regulator device 140 onto the secondary fluid(s) 103 and/or primary fluid 102. The transfer of energy (e.g., thermal, kinetic, and electrical etc.) increases the frequency and intensity of molecular contact between both the primary fluid 102 and secondary fluid(s) 103. This can accelerate the chemical reaction process between the primary fluid 102 and the secondary fluid(s) 103, thus translating to an improvement in both hydration and carbonation kinetics of the cementitious composite material 104 during and after its pump-extrusion process.

The interior of the printhead 100 is constructed to facilitate both expansive and compressive flow behaviors as secondary fluid(s) 103 (e.g., carbon dioxide and/or chemical additives) are progressively introduced to the primary fluid 102 under regulated conditions by the regulator device 140. This enables mixing, diffusion, and compaction of fluids to occur even under the absence of energy-intensive equipment such as an electrical motor. Converging diameters of the nozzle tube (via the convergent-divergent section 125a of the inner bore 125), alongside multiple shearing blades 126, serve as flow restricting components to regulate the dynamic flow and/or spray patterns of the primary fluid 102 (e.g., cementitious mixture) upon introduction of the secondary fluid(s) 103 (e.g., energized fluids) during its pump-extrusion process. The shearing of thixotropic cementitious composite fluid (e.g., the cementitious composite material 104) along an irregular pipe wall and contoured blades (e.g., the shearing blade 126) facilitates deflocculation of the primary fluid 102, thereafter, which can translate to an improved diffusion of secondary fluid(s) 103 under optimal treatment conditions.

Configurations of the printhead 100, such as condition(s) to be regulated, geometries of the interior design, and material of main body 120, may be modified to achieve an optimal equilibrium between carbonation objectives and other requirements such as mechanical properties of the hardened cementitious product (e.g., the cementitious composite material 104) for structural applications (e.g., flexural stiffness, compressive strength, and pore size distribution etc.). Optimal equilibrium between carbonation objectives and other requirements can refer to maximizing carbonation of the 3D printed concrete while enhancing mechanical properties of the 3D printed concrete. For example, excessively high carbon dioxide (e.g., of the secondary fluid(s) 103) injection pressure (e.g., 600 kPa), whether accompanied by steam or not, may negatively impact rheological behavior, buildability, mechanical strength, and pore structure of the cementitious composite material 104. The negative impacts to mechanical properties can occur, for example, due to the interfering effects of carbonation on hydration reactions and pozzolanic activity within the cementitious matrix. At lower pressures (for example, in a range of from about 100 kPa to about 300 kPa), a more favorable balance between these mechanical properties can be achieved, though may not represent the absolute optimum for both carbonation and mechanical properties of the resulting cementitious composite material 104. Additional factors, such as curing conditions, can influence carbonation and mechanical properties of the resulting cementitious composite material 104. The appropriate pressure conditions may be contingent on variables, such as diameter of the inner bore 125, internal geometry of the inner bore 125, and specific mix design formulation (e.g., the compositions of the primary fluid 102 and the secondary fluid(s) 103). Geometries of the interior (e.g., first inlet 122) may be adjusted accordingly depending on the size of aggregates (e.g., in the primary fluid 102) used.

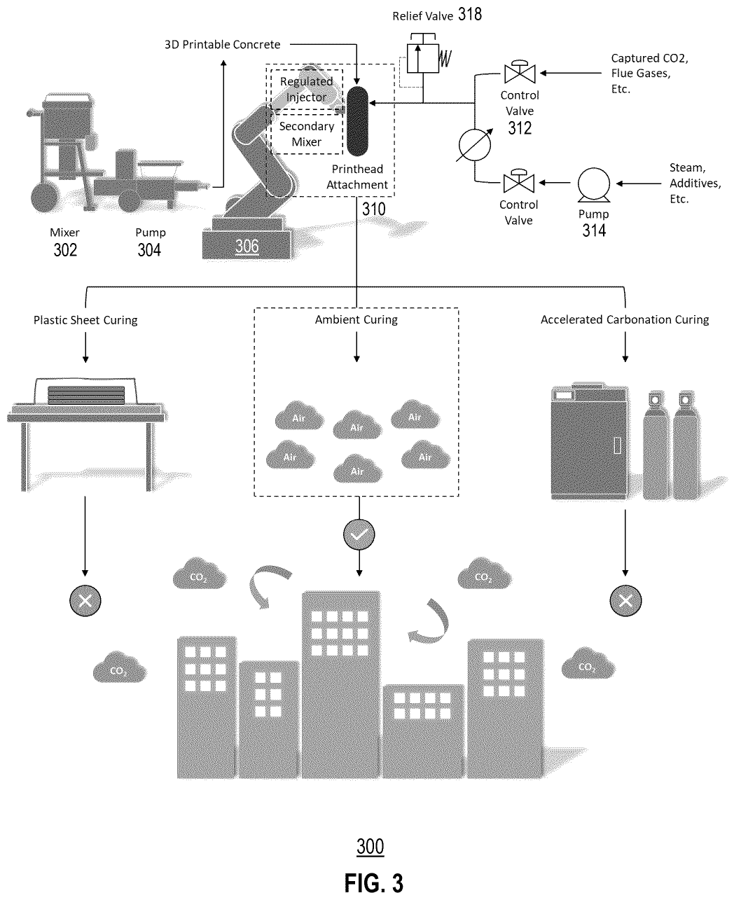

In the event of transferring more than one secondary fluid 103 wherein the sequence is of concern and regulating requirements are distinct for each fluid type, the pressure chamber 128 may be partitioned and/or expanded accordingly with an increased number of secondary inlets 130. Aside from adjustments of orientation and geometry of shearing blades 126 to serve as flow restricting components for regulating dynamic flow and/or spray patterns of the cementitious mixture (e.g., a primary fluid 102) upon introduction of energized fluids (e.g., a secondary fluid 103) during its pump-extrusion process, the same may also be carried out for those of secondary inlets 130, wherein directions and intensities of secondary fluid 103 injection would induce varied deflocculation of the primary cementitious matrix (e.g., of the cementitious mixture 102), thereafter achieving adaptable control over its rheological properties. The described functions, paired with those of the multi-stage convergent-divergent cylinder (e.g., the convergent-divergent section 125a), first inlet 122 and flow restricting components (e.g., the shearing blade 126), can be similar to those of a static mixer; with the exception that instead of using blades which may corrode, wear, and tear over time and may cause clogging, the printhead 100 uses energized secondary fluid(s) 103 that, aside from achieving direct carbonation functions of concrete during 3DCP, also provide a configurable and broader range of control over static mixing of fluids. Further attachment of orifices devices or secondary mixer at the nozzle outlet, in addition to shearing blades, may serve as flow constricting components as well (see, e.g., system 300 of FIG. 3 for additional detail).

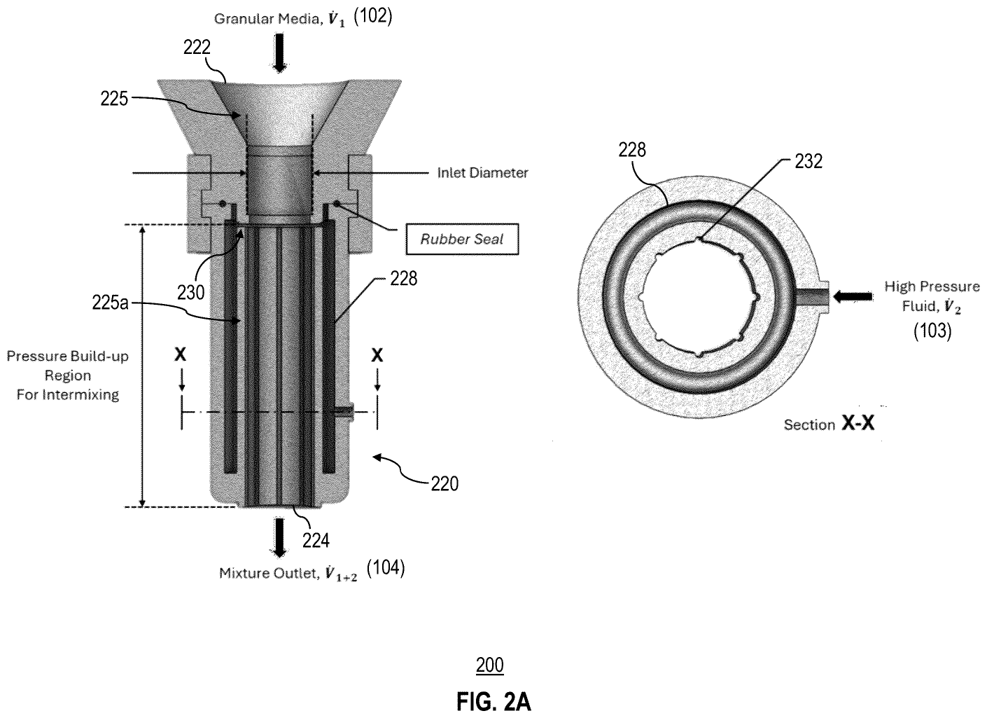

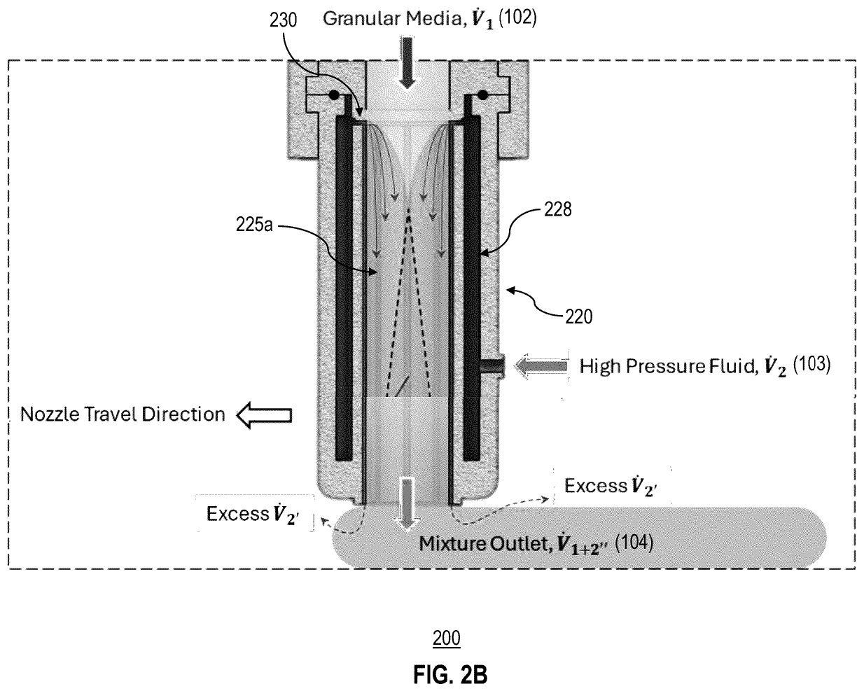

FIG. 2A shows cross-sectional schematic diagrams of the printhead 200, and FIG. 2B shows a cross-sectional schematic diagram of the printhead 200 with representation of fluid flow through the printhead 200. In some cases, the printhead 200 shown in FIGS. 2A and 2B is able to accommodate use of fluids including granular media in additive manufacturing better than the printhead 100 shown in FIG. 1.

Similar to the printhead 100 (shown in FIG. 1), the printhead 200 includes a main body 220. The main body 220 includes a first inlet 222, an outlet nozzle 224, a pressure chamber 228, and a secondary inlet 230. The first inlet 222 is configured to receive a primary fluid, such as the primary fluid 102. The outlet nozzle 224 is configured to discharge a composite material (such as the cementitious composite material 104) for 3D printing of the composite material. The first inlet 222 and the outlet nozzle 224 are located at opposing ends of the main body 220. The main body 220 defines an inner bore 225 extending from the first inlet 222 to the outlet nozzle 224. The primary fluid 102 flows through the inner bore 225 of the main body 220. The inner bore 225 includes a convergent-divergent section 225a. The pressure chamber 228 surrounds at least a portion of the inner bore 225.

The pressure chamber 228 is configured to house a secondary fluid, such as the secondary fluid 103. The secondary inlet 230 extends from the pressure chamber 228 to the convergent-divergent section 225a of the inner bore 225. In some implementations, as shown in FIG. 2A, the main body 220 includes multiple secondary inlets 230, for example, distributed around a circumference of the inner bore 225 in the convergent-divergent section 225a and/or distributed along at least a portion of a longitudinal length of the convergent-divergent section 225a.

While the secondary inlet 130 of the printhead 100 shown in FIG. 1 has a tapered diameter, the secondary inlet 230 of the printhead 200 may not require such a tapered diameter due to the presence of venturi conduit linings 232 in the main body 200. The venturi conduit linings 232 can include narrow channels with small diameters located along the walls of the inner bore 225 to facilitate flow of the secondary fluid(s) 103 through the inner bore 225. The small diameter of the venturi conduit linings 232 can prevent granular material from clogging the venturi conduit linings 232 and interfering with fluid flow. The small diameter of the venturi conduit linings 232 can allow the secondary fluid(s) 103 to flow at an increased pressure, in accordance with Bernoulli's principle. For example, in FIG. 2A, the venturi conduit linings 232 have an example radius of about 2.5 millimeters, based on the anticipated use of a cement mix (primary fluid 102) including solid aggregates with significantly larger dimensions. The diameter of the venturi conduit linings 232 can be adjusted based on the expected particle size distribution of the primary fluid 102. For example, the diameter of the venturi conduit linings 232 are sized to be smaller than the expected particle size distribution of the primary fluid 102, such that the solid particulates present in the primary fluid 102 are prevented from clogging the channels of the venturi conduit linings 232. In some implementations, the cross-sectional flow areas of the venturi conduit linings 232 have a substantially circular shape. In some implementations, the cross-sectional flow areas of the venturi conduit linings 232 have a shape different from a circle, which can be adapted as necessary for the specific cement mix (e.g., primary fluid 102) that is being used to generated the 3D printed concrete (e.g., cementitious composite material 104). The main body 220 includes venturi conduit linings 232 along the inner wall of the convergent-divergent section 225a, which capitalizes on the inherent characteristics of venturi systems to build up pressure relative to the extrusion path's distance within the printhead 200. This venturi mechanism can significantly enhance in-line mixing of granular media (included in the primary fluid 102) and secondary fluid(s) 103 at elevated intensities within the convergent-divergent section 225a.

By extending the length of the pressure build-up region (e.g., the convergent-divergent section 225a), the printhead 200 can effectively overcome challenges associated with increasing inlet pressures that would otherwise be necessary for effective intermixing of the primary fluid 102 and the secondary fluid(s) 103. For example, the presence of larger particle sizes in the primary fluid 102 can necessitate correspondingly larger inlet diameter to accommodate the flow of materials without clogging. As the diameters of the inlets and their filament sizes increase, the pressure of the injected fluid (secondary fluid(s) 103) should also be proportionally increased to ensure adequate mixing and flow. This approach, however, can present a significant challenge, as there is a practical limit to how much the filament diameter can be increased before pressure of the injected fluid (secondary fluid(s) 103) can no longer effectively support the process. The practical limit for the increase in filament diameter can vary depending on various factors, such as diameter of the inner bore 225 and viscosity of the primary fluid 102. As the diameter of the inner bore 225 increases, the secondary fluid(s) 103 will need to travel a greater distance to reach a center of the inner bore 225, which can require an increased pressure to overcome flow resistance. Similarly, a higher viscosity of the primary fluid 102 relates to an increased resistance to shear, thereby requiring an increased pressure for the secondary fluid(s) 103 to penetrate effectively. In pressure of the secondary fluid(s) 103 is insufficient, the secondary fluid(s) 103 may travel only a limited distance from the wall of the inner bore 225, which can cause inhomogeneous mixing of the primary fluid 102 and the secondary fluid(s) 103 as they travel through the inner bore 225, which can be undesired. Beyond this point, mixing of the injected fluid (secondary fluid(s) 103) and the granular material (primary fluid 102) may become inefficient, and may predominantly occur along pipe wall regions within the printhead.

The venturi conduit linings 232 along the inner wall of the convergent-divergent section 225a can reduce the use of excess primary and/or secondary fluid(s) (e.g., the primary fluid 102 and/or the secondary fluid(s) 103) while also mitigating safety risks associated with operation at high pressure levels. The venturi conduit linings 232 along the inner wall of the convergent-divergent section 225a can additionally function as a cleaning system for the printhead 200. For example, the venturi conduit linings 232 along the inner wall of the convergent-divergent section 225a can maintain a clear and efficient flow path for the primary and secondary fluids (e.g., the primary fluid 102 and the secondary fluid(s) 103) while prevent excessive buildup of hardened materials, which can lead to clogging.

The venturi conduit linings 232 along the inner wall of the convergent-divergent section 225a can channel secondary fluid(s) 103 into the primary fluid 102 effectively while also providing a natural, unobstructed relief system for any excess fluids injected into the inner bore 225. As such, channeling of aggregate particles would therefore be of less concern with streams of injected fluid (e.g., the secondary fluid(s) 103) forming a lubrication layer along the walls of the inner bore 225 via the venturi conduit linings. In applications (such as 3D concrete printing), this configuration can allow for adjustment of the stand-off distance between the outlet nozzle 224 and a floor wall (upon which the concrete is 3D printed), thereby enhancing the intensity of intermixing near the outlet nozzle 224. Such adjustments can facilitate a significant increase in the pressure differential between the internal and external compartments of the printhead 200. This increase in pressure differential can, in some cases, accelerate the chemical reaction(s) between the primary fluid 102 and the secondary fluid(s) 103, which can optimize the mixing process and improve the quality and uniformity of the extruded filament (cementitious composite material 104).

The inner bore 225 can include a shearing section. In implementations where the inner bore 225 includes the shearing section, similar to the printhead 100 (shown in FIG. 1), the printhead 200 can include at least one implementation of the shearing blade 126 (shown in FIG. 1) disposed within the shearing section. The pressure chamber 228 can be coupled to a regulator device (not shown) (such as the regulator device 140 for providing the secondary fluid(s) 103 to the pressure chamber 228).

FIG. 2B shows a cross-sectional schematic diagram of the example printhead of FIG. 2A showing flow of fluid through the example printhead 200. The primary fluid 102 (including granular media) flows into the inner bore 225 via the first inlet 222. The secondary fluid 103 flows into the pressure chamber 228 (for example, regulated by the regulator device 140, not shown). As the primary fluid 102 flows through the inner bore 225, the secondary fluid 103 flows from the pressure chamber 228 into the convergent-divergent section 225a of the inner bore 225 via the secondary inlet 230.

Within the convergent-divergent section 225a of the inner bore 225, the primary fluid 102 and the secondary fluid(s) 103 mix to form the cementitious composite material 104. In cases in which the printhead 200 includes shearing blade(s) (such as the shearing blade 126, shown in FIG. 1), the shearing blade(s) can promote interaction and mixing of the primary fluid 102 and the secondary fluid(s) 103. The cementitious composite material 104 discharges from the outlet nozzle 224 for the 3D printing process.

FIG. 3 is a schematic diagram of an example system 300 that includes a printhead, which can be used for additive manufacturing, for example, with concrete. The system 300 includes a mixer 302. A cement mix (such as the primary fluid 102) can be introduced to the mixer 302. The cement mix (for example, the primary fluid 102) can include typical components of cement, (such as lime (Ca(OH)₂), silica (SiO₂), alumina (Al₂O₃), iron oxide (Fe₂O₃), calcium sulfate (CaSO₄), magnesium oxide (MgO), sulfur trioxide (SO₃), and alkaline). The mixer 302 can mix components of the cement mix to ensure that the cement mix is a homogeneous mixture.

The system 300 includes a pump 304 and an additive manufacturing printer 306. The pump 304 flows the cement mix from the mixer 302 to the printer 306. The system 300 includes a printhead 310 attached to the printer 306. The printer 306 directs flow of the cement mix through the printhead 310. The printhead 310 can be, for example, an implementation of the printhead 100 (shown in FIG. 1) or the printhead 200 (shown in FIGS. 2A-2C).

The system 300 includes a first control valve 312 configured to control flow of carbon dioxide to the printhead 310. The system 300 includes a pump 314 and a second control valve 316. The pump 314 and the second control valve 316 are cooperatively configured to control flow of additives (such as steam and/or chemical additives) to the printhead 310. The first control valve 312, the pump 314, and the second control valve 316 work together to provide a secondary fluid (such as the secondary fluid 103) including the carbon dioxide and additives to the printhead 310. The system 300 can include a relief valve 318 for relieving pressure, for example, in an overpressure scenario to avoid uncontrolled release and protect equipment of the system 300. The cement mix (e.g., the cementitious mixture 102) and the secondary fluid 103 mix and interact with one another within the printhead 310. The printer 306 moves the printhead 310 while discharging the mixture of the cement mix (e.g., the cementitious mixture 102) and the secondary fluid 103 as a cementitious composite material (such as the cementitious composite material 104) from the printhead 310 to additively manufacture a composite material (such as a concrete material). Once printed by the printer 306, the composite material is cured. The composite material can be cured, for example, by plastic sheet curing, ambient curing, or accelerated carbonation curing.

### Examples

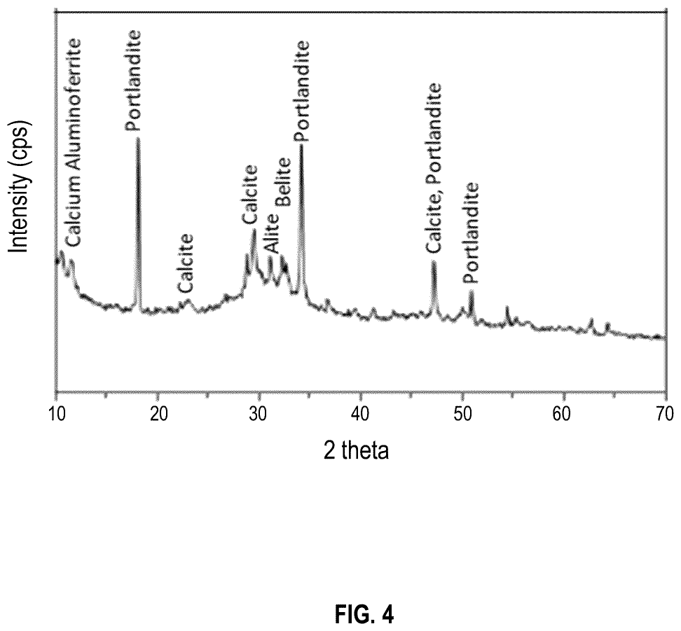

FIG. 4 is a plot of X-ray diffraction (XRD) spectra of a reference cement mix, which was subjected to seven days of unconfined open-air curing in an environment with an operating temperature of 22±3 degrees Celsius (° C.) and a relative humidity (RH) of 55±10%. In the plot shown in FIG. 4, the y-axis is the X-ray diffraction intensity measured in counts per second (cps), and the x-axis is double the diffraction angle (theta, 0) of the incoming electromagnetic wave, which is why the axis is labeled “2 theta”. As shown in the plot of FIG. 4, the XRD spectra indicates the presence of calcium aluminoferrite, portlandite, calcite, alite, belite, and calcite in the reference cement mix.

Table 1 provides the composition of the reference cement mix (e.g., primary fluid 102) whose XRD spectra is shown in FIG. 4, which was used in testing the printhead design (e.g., printhead 100) for 3D printing of concrete. The reference cement mix whose composition is shown in Table 1 was 3D printed at a carbon dioxide partial pressure of one bar (100 kilopascals (kPa)) with 8.75 milliliters per minute (mL/min) of simultaneous steam flow, which facilitated an increase in buildable height for the 3D printed concrete from 260 millimeters (mm) to 280 mm, resulting in an increase of 8% in buildable height. It is noted, however, that printability improvements, efficiency of carbon sequestration, and influence on filament surfaces may be affected by carbon dioxide and steam injection parameters, toolpath designs, and 3D printer settings.

TABLE 1
Reference mix for concrete 3D printing

| Component | Weight percent (wt. %) |
|---|---|
| Cement | 20.7 |
| Slag | 13.8 |
| Sand | 43.1 |
| Silica Fume | 7.54 |
| Water | 14.6 |
| Superplasticizer | 0.311 |

Table 2 provides the composition of a reference cement mix (e.g., primary fluid 102) that was used in testing the printhead design (e.g., printhead 200) for 3D printing of abrasive concrete. The reference cement mix whose composition is shown in Table 2 included fine aggregates (i.e., river sand at under 2 mm particle size) in excess of 50 wt. % of the reference cement mix, which imparted stiffness and abrasiveness. Despite the presence of fine aggregates, the reference cement mix was successfully 3D printed without instances of clogging.

TABLE 2
Reference mix for abrasive concrete 3D printing

| Component | Weight percent (wt. %) |
|---|---|
| Portland Cement | 32.2 |
| Fine Aggregates | 51.7 |
| Silica Fume | 12.7 |
| Water | 3.22 |
| Superplasticizer | 0.231 |

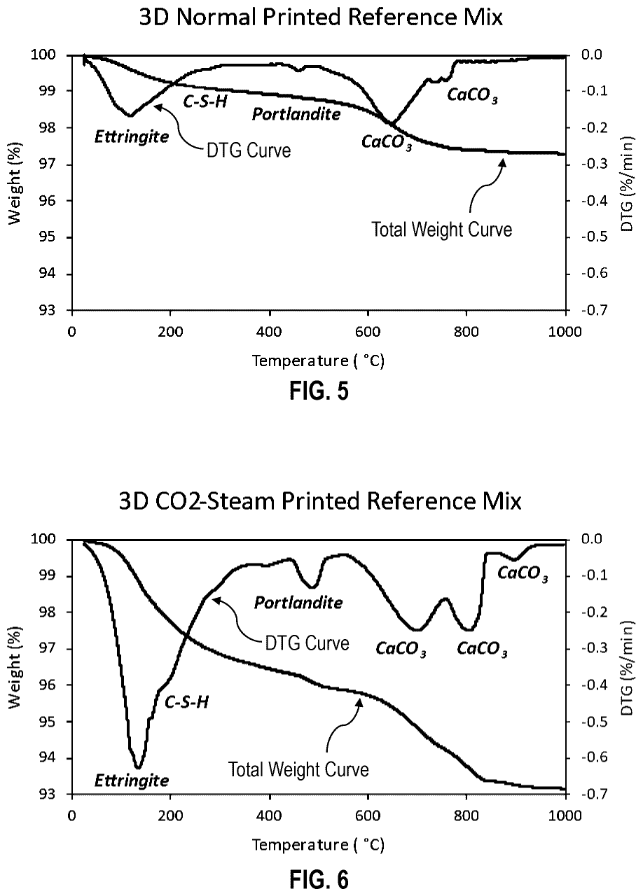

FIG. 5 is a plot showing derivative thermogravimetry curves of a thermogravimetric analysis (TG-DTG) for the reference cement mix (whose composition is provided in Table 1). FIG. 6 is a plot showing TG-DTG curves for the reference cement mix (whose composition is provided in Table 1) with injected carbon dioxide and steam additives. In FIGS. 5 and 6, the left axis is total weight percent of the sample as temperature is increased, and the right axis is the rate of change of mass with respect to time (also referred to as the derivative thermogravimetric (DTG) curve) whose units are weight percent per minute (%/min). As shown by the plots in FIGS. 5 and 6, incorporation of carbon dioxide and steam facilitated 1) rapid formation of ettringite and portlandite during early ages of curing, which suggests enhanced early hydration which helps reduce early cracking and improve structural stability, and 2) enhanced C—S—H gel formation and CaCO₃ precipitation, the latter of which indicates an increase in CO₂ sequestration, particularly CaCO₃ minerals with higher thermodynamic stability and higher crystallinity.

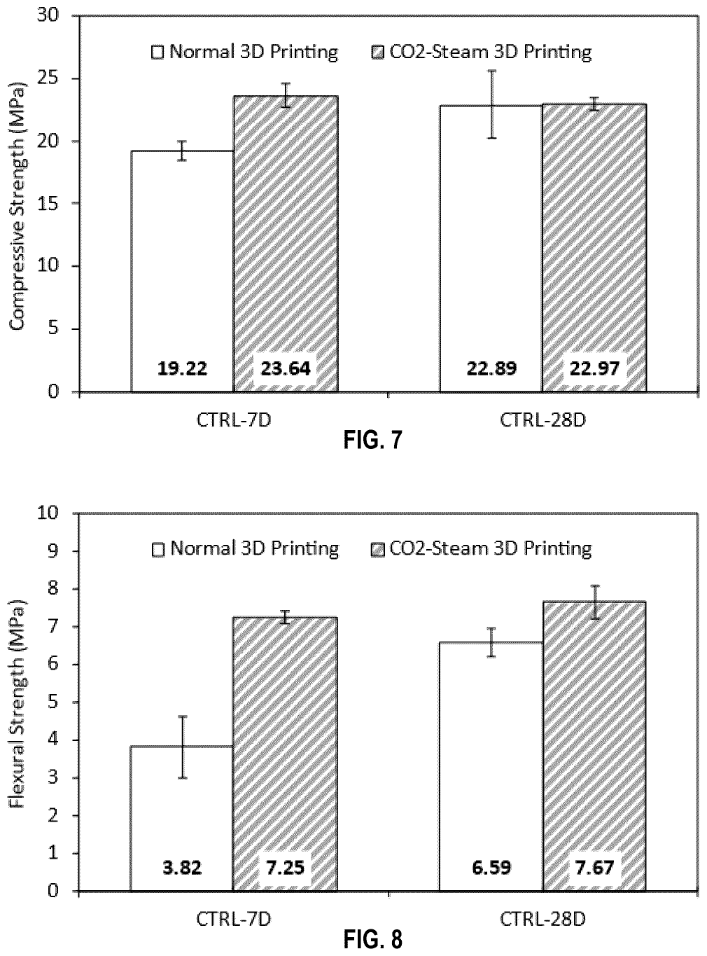

FIG. 7 is a plot comparing compressive strength of cement samples (whose composition is provided in Table 1) without injection of carbon dioxide and steam additives (blank) and with injection of carbon dioxide and steam additives (patterned). FIG. 8 is a plot comparing flexural strength of cement samples (whose composition is provided in Table 1) without injection of carbon dioxide and steam additives (blank) and with injection of carbon dioxide and steam additives (patterned). In FIGS. 7 and 8, the left axis is total weight percent of the sample as temperature is increased, and the right axis is DTG curve whose units are %/min. As shown by the plots in FIGS. 7 and 8, integration of carbon dioxide and steam during 3D concrete printing resulted in a substantial increase in compressive and flexural strength in early ages by 23.0% and 89.8%, respectively. In particular, the carbon dioxide and steam integrated 3D printing concrete samples achieved its 28-day peak mechanical strength within its 7-day open-air unconfined curing age, showing its potential in rapid strength increments. Regarding flexural strength, the control sample (blank, without carbon dioxide and steam injection) observed an increase from 3.82 megapascals (MPa) to 6.59 MPa between its 7-day and 28-day curing age. Meanwhile, the carbon dioxide and steam integrated sample observed an increase from 7.25 MPa to 7.67 MPa, where its 7-day flexural strength exceeded that of the 28-day sample without carbon dioxide and steam integration. A similar trend was observed regarding compressive strength.

In each of the configurations described, process streams (also referred to as “fluids”) can be flowed using one or more flow control systems. A flow control system can include one or more flow pumps to pump the process streams, one or more flow pipes through which the process streams are flowed, and one or more valves to regulate the flow of streams through the pipes.

In some implementations, a flow control system can be operated manually. For example, an operator can set a flow rate for each pump by changing the position of a valve (open, partially open, or closed) to regulate the flow of the process streams through the pipes in the flow control system. Once the operator has set the flow rates and the valve positions for all flow control systems distributed across the gas processing plant, the flow control system can flow the streams within a unit or between units under constant flow conditions, for example, constant volumetric or mass flow rates. To change the flow conditions, the operator can manually operate the flow control system, for example, by changing the valve position.

In some implementations, a flow control system can be operated automatically. For example, the flow control system can be connected to a computer system to operate the flow control system. The computer system can include a computer-readable medium storing instructions (such as flow control instructions) executable by one or more processors to perform operations (such as flow control operations). For example, an operator can set the flow rates by setting the valve positions for all flow control systems distributed across the gas processing plant using the computer system. In such implementations, the operator can manually change the flow conditions by providing inputs through the computer system. In such implementations, the computer system can automatically (that is, without manual intervention) control one or more of the flow control systems, for example, using feedback systems implemented in one or more units and connected to the computer system. For example, a sensor (such as a pressure sensor or temperature sensor) can be connected to a pipe through which a process stream flows. The sensor can monitor and provide a flow conditions (such as a pressure or temperature) of the process stream to the computer system. In response to the flow condition deviating from a set point (such as a target pressure value or target temperature value) or exceeding a threshold (such as a threshold pressure value or threshold temperature value), the computer system can automatically perform operations. For example, if the pressure or temperature in the pipe exceeds the threshold pressure value or the threshold temperature value, respectively, the computer system can provide a signal to open a valve to relieve pressure or a signal to shut down process stream flow.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

### Embodiments

In an example implementation (or aspect), a printhead for three-dimensional printing of concrete comprises: a main body, comprising: a multi-stage, convergent-divergent cylinder with shearing blades attached towards a nozzle outlet; a pressure chamber surrounding the convergent-divergent cylinder for temporary storage and regulated processing of a secondary fluid; and a secondary inlet with a tapered diameter for a transfer of the secondary fluid from the pressure chamber to the multi-stage, convergent-divergent cylinder; and a regulator device.

In an example implementation (or aspect), a system comprises: an additive manufacturing printer; a printhead attached to the additive manufacturing printer, wherein the additive manufacturing printer is configured to flow a primary fluid comprising a cementitious material through the printhead while moving the printhead, wherein the printhead comprises: a main body comprising: a first inlet configured to receive the primary fluid; an outlet nozzle, wherein the first inlet and the outlet nozzle are located at opposing ends of the main body, wherein the main body defines an inner bore extending from the first inlet to the outlet nozzle, wherein the inner bore comprises a convergent-divergent section and a shearing section; a shearing blade disposed within the shearing section of the inner bore; a pressure chamber surrounding at least a portion of the inner bore, wherein the pressure chamber is configured to house a secondary fluid; and a secondary inlet extending from the pressure chamber to the convergent-divergent section of the inner bore for transferring the secondary fluid from the pressure chamber to the inner bore, wherein the shearing blade is configured to provide shear force onto the primary fluid and the secondary fluid, thereby promoting mixing of and interaction between the primary fluid and the secondary fluid to produce a cementitious composite material, wherein the outlet nozzle is configured to discharge the cementitious composite material; and a regulator device coupled to the pressure chamber of the main body for providing the secondary fluid to the pressure chamber.

In an example implementation (or aspect) combinable with any other example implementation (or aspect), the secondary inlet has a tapered diameter that decreases toward the inner bore.

In an example implementation (or aspect) combinable with any other example implementation (or aspect), the shearing section has a venturi shape with a converging cross-sectional flow area followed by a diverging cross-sectional flow area.

In an example implementation (or aspect) combinable with any other example implementation (or aspect), the main body comprises a plurality of venturi conduit linings spanning longitudinally along at least a portion of the convergent-divergent section of the inner bore.

In an example implementation (or aspect) combinable with any other example implementation (or aspect), the plurality of venturi conduit linings are distributed circumferentially around at least the portion of the convergent-divergent section of the inner bore.

In an example implementation (or aspect) combinable with any other example implementation (or aspect), the system comprises the primary fluid and the secondary fluid.

In an example implementation (or aspect) combinable with any other example implementation (or aspect), the secondary fluid comprises carbon dioxide, steam, or both.

In an example implementation (or aspect) combinable with any other example implementation (or aspect), the system comprises a flow control system configured to provide the secondary fluid to the regulator device.

In an example implementation (or aspect), a method comprises flowing a primary fluid comprising a cementitious material into an inner bore of a printhead; flowing a secondary fluid comprising carbon dioxide, steam, or both into a pressure chamber surrounding at least a portion of the inner bore of the printhead; flowing the secondary fluid from the pressure chamber into the inner bore of the printhead while the primary fluid flows within the inner bore of the printhead to mix the secondary fluid with the primary fluid within the inner bore of the printhead and form a cementitious composite material; and discharging the cementitious composite material from the inner bore of the printhead.

In an example implementation (or aspect) combinable with any other example implementation (or aspect), the method comprises moving the printhead while discharging the cementitious composite material from the inner bore of the printhead.

In an example implementation (or aspect) combinable with any other example implementation (or aspect), the secondary fluid is flowed from the pressure chamber into a convergent-divergent section of the inner bore of the printhead.

In an example implementation (or aspect) combinable with any other example implementation (or aspect), the method comprises applying shear to the cementitious composite material within the inner bore of the printhead to homogenize the cementitious composite material.

In an example implementation (or aspect) combinable with any other example implementation (or aspect), the shear is applied to the cementitious composite material is applied by a shearing blade disposed within a shearing section of the inner bore of the printhead.

In an example implementation (or aspect) combinable with any other example implementation (or aspect), the shearing section of the inner bore of the printhead has a venturi shape with a converging cross-sectional flow area followed by a diverging cross-sectional flow area.

In an example implementation (or aspect) combinable with any other example implementation (or aspect), flowing the primary fluid into the inner bore of the printhead comprises flowing the primary fluid into a first inlet of the printhead.

In an example implementation (or aspect) combinable with any other example implementation (or aspect), the secondary fluid is flowed from the pressure chamber into the inner bore of the printhead through a secondary inlet extending from the pressure chamber to a convergent-divergent section of the inner bore.

In an example implementation (or aspect) combinable with any other example implementation (or aspect), discharging the cementitious composite material from the inner bore of the printhead comprises discharging the cementitious composite material from an outlet nozzle of the printhead.

In an example implementation (or aspect) combinable with any other example implementation (or aspect), the printhead comprises a plurality of venturi conduit linings spanning longitudinally along at least a portion of the convergent-divergent section of the inner bore of the printhead.

In an example implementation (or aspect) combinable with any other example implementation (or aspect), the method comprises mixing, by the plurality of venturi conduit linings, the primary fluid and the secondary fluid within the convergent-divergent section of the inner bore of the printhead.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed:

1. A printhead for three-dimensional printing of concrete, the printhead comprising:
a main body, comprising:
a multi-stage, convergent-divergent cylinder with shearing blades attached towards a nozzle outlet;
a pressure chamber surrounding the convergent-divergent cylinder for temporary storage and regulated processing of a secondary fluid; and
a secondary inlet with a tapered diameter for a transfer of the secondary fluid from the pressure chamber to the multi-stage, convergent-divergent cylinder; and
a regulator device.

2. A system comprising:
an additive manufacturing printer;
a printhead attached to the additive manufacturing printer, wherein the additive manufacturing printer is configured to flow a primary fluid comprising a cementitious material through the printhead while moving the printhead, wherein the printhead comprises:
a main body comprising:
a first inlet configured to receive the primary fluid;
an outlet nozzle, wherein the first inlet and the outlet nozzle are located at opposing ends of the main body, wherein the main body defines an inner bore extending from the first inlet to the outlet nozzle, wherein the inner bore comprises a convergent-divergent section and a shearing section;
a shearing blade disposed within the shearing section of the inner bore;
a pressure chamber surrounding at least a portion of the inner bore,
wherein the pressure chamber is configured to house a secondary fluid; and
a secondary inlet extending from the pressure chamber to the convergent-divergent section of the inner bore for transferring the secondary fluid from the pressure chamber to the inner bore, wherein the shearing blade is configured to provide shear force onto the primary fluid and the secondary fluid, thereby promoting mixing of and interaction between the primary fluid and the secondary fluid to produce a cementitious composite material, wherein the outlet nozzle is configured to discharge the cementitious composite material; and
a regulator device coupled to the pressure chamber of the main body for providing the secondary fluid to the pressure chamber.

3. The system of claim 2, wherein the secondary inlet has a tapered diameter that decreases toward the inner bore.

4. The system of claim 2, wherein the shearing section has a venturi shape with a converging cross-sectional flow area followed by a diverging cross-sectional flow area.

5. The system of claim 2, wherein the main body comprises a plurality of venturi conduit linings spanning longitudinally along at least a portion of the convergent-divergent section of the inner bore.

6. The system of claim 5, wherein the plurality of venturi conduit linings are distributed circumferentially around at least the portion of the convergent-divergent section of the inner bore.

7. The system of claim 6, comprising the primary fluid and the secondary fluid.

8. The system of claim 7, wherein the secondary fluid comprises carbon dioxide, steam, or both.

9. The system of claim 8, comprising a flow control system configured to provide the secondary fluid to the regulator device.

10. A method comprising:
flowing a primary fluid comprising a cementitious material into an inner bore of a printhead;
flowing a secondary fluid comprising carbon dioxide, steam, or both into a pressure chamber surrounding at least a portion of the inner bore of the printhead;
flowing the secondary fluid from the pressure chamber into the inner bore of the printhead while the primary fluid flows within the inner bore of the printhead to mix the secondary fluid with the primary fluid within the inner bore of the printhead and form a cementitious composite material; and
discharging the cementitious composite material from the inner bore of the printhead.

11. The method of claim 10, comprising moving the printhead while discharging the cementitious composite material from the inner bore of the printhead.

12. The method of claim 11, wherein the secondary fluid is flowed from the pressure chamber into a convergent-divergent section of the inner bore of the printhead.

13. The method of claim 12, comprising applying shear to the cementitious composite material within the inner bore of the printhead to homogenize the cementitious composite material.

14. The method of claim 13, wherein the shear is applied to the cementitious composite material is applied by a shearing blade disposed within a shearing section of the inner bore of the printhead.

15. The method of claim 14, wherein the shearing section of the inner bore of the printhead has a venturi shape with a converging cross-sectional flow area followed by a diverging cross-sectional flow area.

16. The method of claim 12, wherein flowing the primary fluid into the inner bore of the printhead comprises flowing the primary fluid into a first inlet of the printhead.

17. The method of claim 16, wherein the secondary fluid is flowed from the pressure chamber into the inner bore of the printhead through a secondary inlet extending from the pressure chamber to a convergent-divergent section of the inner bore.

18. The method of claim 17, wherein discharging the cementitious composite material from the inner bore of the printhead comprises discharging the cementitious composite material from an outlet nozzle of the printhead.

19. The method of claim 16, wherein the printhead comprises a plurality of venturi conduit linings spanning longitudinally along at least a portion of the convergent-divergent section of the inner bore of the printhead.

20. The method of claim 19, comprising mixing, by the plurality of venturi conduit linings, the primary fluid and the secondary fluid within the convergent-divergent section of the inner bore of the printhead.
